(19) United States
(12) Patent Application Publication
(10) Pub. No.: US 2010/0312905 A1
(43) Pub. Date: Dec. 9, 2010

(54) Sustaining Live Interactive Streaming

(76) Inventors: Dov Sandmann, Herzeliya (IL); Lior Homen, Beit Dagen (IL)

Correspondence Address: The Law Office of Michael E. Kondoudis, 888 16th Street, N.W., Suite 800, Washington, DC, 20006, US

(21) Appl. No.: 12/480,273

(22) Filed: Jun. 8, 2009

(51) Int. Cl. G06F 15/16; G06F 15/173

(52) U.S. Cl. 709/231; 709/224; 709/232

(57) ABSTRACT

A method of sustaining live interactive streaming of multimedia content from a transmitter to a receiver through a communication network exhibiting channel congestion. The method comprises: transmitting the multimedia content encoded in a first encoding scheme characterized by a high bit rate; receiving and reconstructing the transmitted multimedia content through a dynamic switch lag buffer; measuring, recording and analyzing an incoming packet delay at the receiver; predicting a packet delay based on the analyzed incoming packet delay; predicting an increase in channel congestion by detecting an increase in the predicted packet delay, and notifying the transmitter thereof, and transmitting thereupon the multimedia content using a second encoding scheme characterized by a low bit rate. Continuous live interactive streaming of the multimedia content is sustained despite the increase in channel congestion by a fast and visually seamless switching between the encoding schemes, the timely prediction and the switch lag buffer.

### TECHNICAL FIELD

The present invention, in some embodiments thereof, relates to the field of communication, and more particularly but not exclusively to streaming methods.

### DISCUSSION OF RELATED ART

Streaming, and especially live broadcasting, is very sensitive to changing bandwidth. When the available bandwidth diminishes, streaming may be interrupted or severely delayed.

Prior to setting forth the background of the related art, it may be helpful to set forth definitions of certain terms that will be used hereinafter.

The term “transmitter” as used herein in this application, is defined as a server or a program applicable to a computer and/or other devices such as cellular phones or hand held devices that provide services to other computer programs and/or the computer(s) and/or other devices such as cellular phones or hand held devices running it.

The term “receiver” as used herein in this application is defined as a client or an application that accesses services from a server via a network and/or the physical hardware device(s) running the application.

The term “Round Trip Time” (RTT) as used herein in this application is defined as the time for sending a message from the receiver to the transmitter and back, or as the time for sending a message from the transmitter to the receiver and back.

The term “live interactive stream of multimedia content” as used herein in this application, is defined as streaming media that is characterized by a continuous transmission and reception of the multimedia content that takes place in real time and allows reliable interaction between at least two parties. Examples are video conferencing, games as well as live broadcasting with delays characteristically smaller than 2 seconds. Sustaining a live interactive stream of multimedia content faces the challenge of preventing buffer underrun due to congestion in the transmission network.

### BRIEF SUMMARY

Embodiments of the present invention provide a computer implemented method of sustaining live interactive streaming of multimedia content from a transmitter to a receiver through a communication network exhibiting channel congestion. According to one aspect of some embodiments of the invention, there is provided a method of: encoding multimedia content with at least two encoding schemes simultaneously, a first encoding scheme characterized by a predefined high bit rate and a second encoding scheme characterized by a predefined low bit rate; transmitting the multimedia content using the first encoding scheme; receiving and reconstructing the transmitted multimedia content through a dynamic switch lag buffer characterized by a predefined buffer size; measuring, recording and analyzing an incoming packet delay at the receiver; predicting a packet delay based on the analyzed incoming packet delay; predicting an increase in channel congestion by detecting an increase in the predicted packet delay; notifying the transmitter of the detected channel congestion; and transmitting the multimedia content using the second encoding scheme upon receiving the notification of the detected channel congestion from the receiver. Predicting the packet delay is carried out in a real-time and non-obtrusive manner, and continuous live interactive streaming of the multimedia content is sustained despite the increase in channel congestion by a fast and visually seamless switching between the encoding schemes, that is guaranteed to take effect at the receiver before the receiver buffer under-runs.

Embodiments of the present invention provide a data processing system for sustaining live interactive streaming of multimedia content through a communication network comprising at least one communication link and exhibiting channel congestion. One data processing system comprising a transmitter connected via the communication network to a receiver. The transmitter comprises at least one encoder arranged to encode the multimedia content with at least two encoding schemes simultaneously, a first encoding scheme characterized by a predefined high bit rate and a second encoding scheme characterized by a predefined low bit rate, and wherein the transmitter is arranged to transmit the multimedia content using the first encoding scheme. The receiver comprises: a dynamic switch lag buffer characterized by a predefined buffer size and is arranged to receive the transmitted multimedia content; and a control unit arranged to measure, record and analyze an incoming packet delay, predict a packet delay, and predict an increase in channel congestion by detecting an increase in the predicted packet delay. The receiver is further arranged to notify the transmitter of the detected channel congestion, and the transmitter is further arranged to switch to transmitting the multimedia content using the second encoding scheme upon receiving the notification of the detected channel congestion from the receiver. The predicting the packet delay is carried out in a fast and non-obtrusive manner and continuous live interactive streaming of the multimedia content is sustained despite the increase in channel congestion by a fast and visually seamless switching between the encoding schemes.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIGS. 1A and 1B are a flowchart 90 of a computer implemented method of sustaining live interactive streaming through a communication network exhibiting channel congestion, according to some embodiments of the invention; and

FIG. 2 is a block diagram of a data processing system for sustaining live interactive streaming of multimedia content through channel congestion, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For a better understanding of the invention, the usages of the following terms in the present disclosure are defined in a non-limiting manner:

The term “visually seamless switching” as used herein in this application, is defined as an operation exhibiting a visual continuity upon changes in the characteristics of transmission, such as bit rate, GOP size etc. The transition between streams of varying characteristics is visually continuous, causing neither disruption nor confusion for the end viewer.

The term “multimedia content” as used herein in this application is defined as video content that may be enhanced by other forms of content such as audio content, text, interactivity content forms, animation and so forth.

The term “switch lag” as used herein in this application is defined as the between initiation of a request at the receiver to switch and clearance of a channel congestion by the switching.

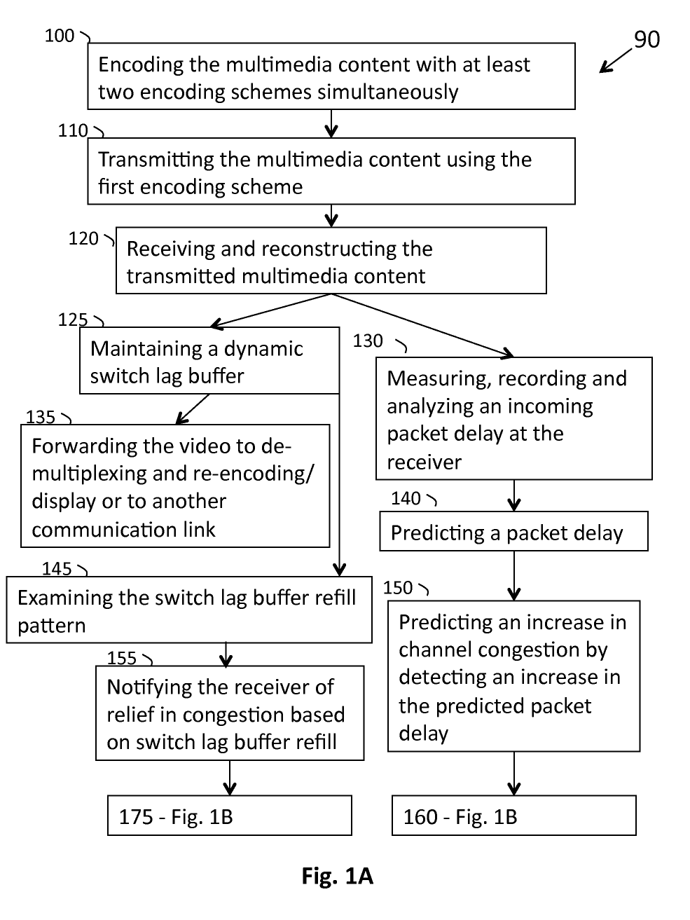

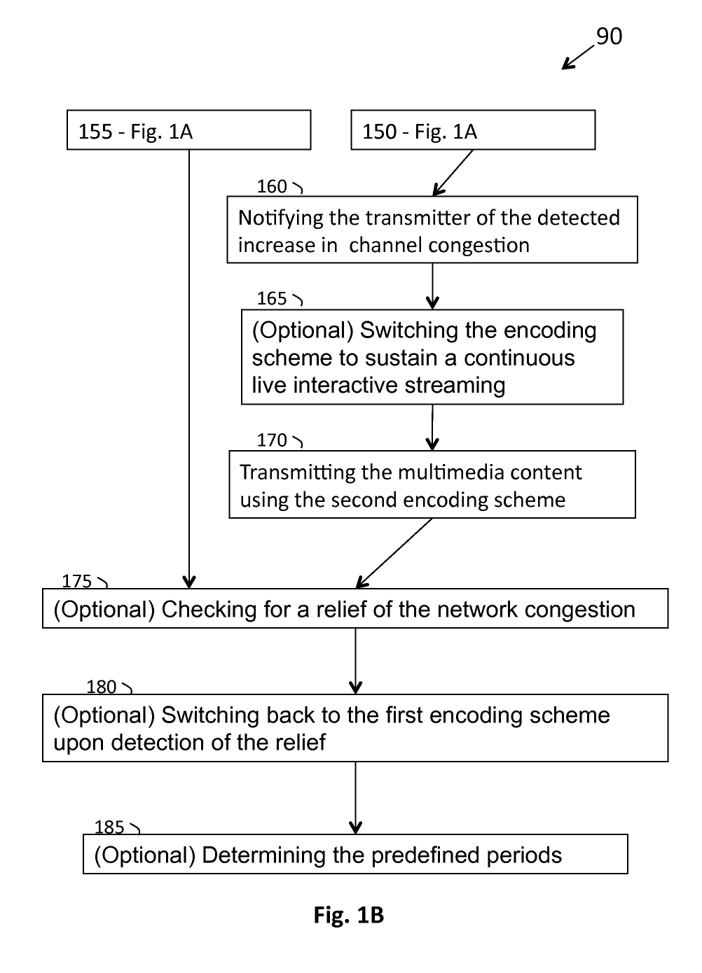

FIGS. 1A and 1B are a flowchart of a computer implemented method of sustaining live interactive streaming of multimedia content from a transmitter to a receiver through a communication network exhibiting channel congestion, according to some embodiments of the invention. The computer implemented method comprises the stage of encoding the multimedia content with at least two encoding schemes simultaneously (stage 100). A first encoding scheme is characterized by a predefined high bit rate, while a second encoding scheme is characterized by a predefined low bit rate. The computer implemented method further comprises the following stages: transmitting the multimedia content using the first encoding scheme (stage 110); receiving and reconstructing the transmitted multimedia content through a dynamic switch lag buffer characterized by a predefined buffer size and switch lag buffer refill state (stage 120); measuring, recording and analyzing an incoming packet delay at the receiver (stage 130); predicting a packet delay (stage 140) based on the analyzed incoming packet delay; predicting an increase in channel congestion by detecting an increase in the predicted packet delay (stage 150); notifying the transmitter of the detected channel congestion (stage 160); and transmitting the multimedia content using the second encoding scheme upon receiving the notification of the detected channel congestion from the receiver (stage 170). In parallel, according to some embodiments after receiving and reconstructing the transmitted multimedia content (stage 120), the computer implemented method further comprises the following stages: maintaining a dynamic switch lag buffer, having a switch lag buffer refill pattern (stage 125); forwarding the video to de-multiplexing and re-encoding/display or to another communication link (stage 135); examining the switch lag buffer refill pattern (stage 145) thereby predicting a decrease in channel congestion; and notifying the receiver of relief in congestion based on switch lag buffer refill (stage 155).

According to some embodiments of the invention, predicting the packet delay (stage 140) is carried out in a fast and non-obtrusive manner and the continuous live interactive streaming of the multimedia content is sustained despite the increase in channel congestion by a fast and visually seamless switching between the encoding schemes.

According to some embodiments of the invention, the computer implemented method further comprises switching the encoding scheme such as to sustain a continuous live interactive streaming of the multimedia content despite the channel congestion.

According to some embodiments of the invention, the multimedia content is group-of-pictures (GOP)-based. The first encoding scheme may be further characterized by a first predefined GOP and a predefined sequence of I, P and B frames, and the second encoding scheme may be further characterized by a second predefined GOP and a second predefined sequence of I, P and B frames.

Switching (stage 165) may be carried out in respect to the first predefined GOP and to the second predefined GOP such as to maintain continuous streaming. The multimedia content may have any MPEG standard for video and transport. The system and method may use for switching SI and SP frames, or any other method, relating to the coding pattern.

Alternatively, the system and method may use any number of encoders as switching alternatives. Encoders may be characterized by different predefined sizes of GOP and of video encoding schemes, and switching may involve changing between the predefined sizes of GOP such as to provide continuous content. For example, a low GOP may be coupled to the predefined low bit rate and a high GOP may be coupled to the predefined high bit rate.

According to some embodiments of the invention, prediction (stages 130, 140, 150, 160, 165, 170) and forwarding the multimedia (stages 125, 135, 145, 155) are simultaneous. One of the ways to know of channel congestion relief is to know about the switch lag buffer refill, after it was used by down switch.

According to some embodiments of the invention, the continuity of the stream can be defined as a maximal accepted percentage of packet loss, and may be measured in the system and method. Optionally, this measure may be used to evaluate the efficiency of various switching methods and used to improve the operation of the system and method. The maximal accepted percentage of packet loss may be adapted in relation to the multimedia content and its use purposes.

According to some embodiments of the invention, the computer implemented method further comprises checking at predefined periods for a relief of the network congestion (stage 175). The computer implemented method may further comprise switching back to the first encoding scheme upon detection of the relief of the network congestion (stage 180). The computer implemented method may further comprise determining the predefined periods (stage 185) in relation to the round-trip-time (RTT), to the switching time at the transmitter, parameters of the encoding schemes, etc. Predicting the packet delay (stage 140) is carried out in a real-time and non-obtrusive manner, and continuous live interactive streaming of the multimedia content is sustained despite the increase in channel congestion by a fast and visually seamless switching between the encoding schemes, that is guaranteed to take effect at the receiver before the receiver buffer under-runs.

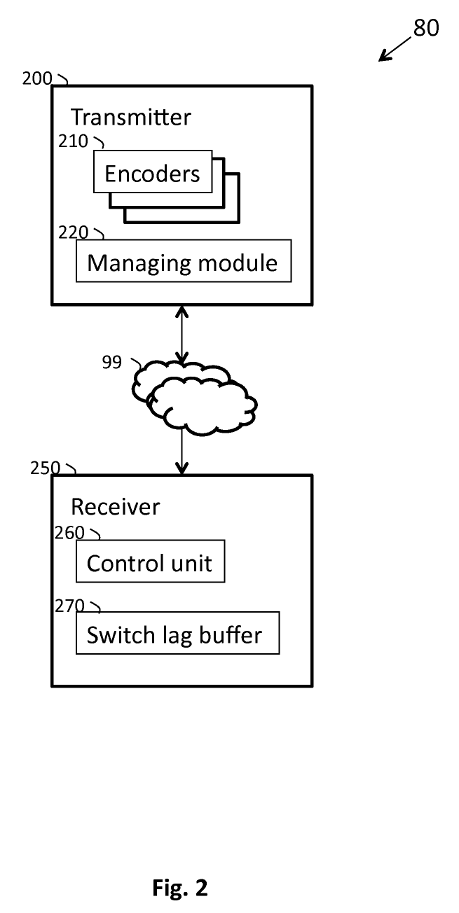

FIG. 2 is a block diagram of a data processing system 80 for sustaining live interactive streaming of multimedia content through at least one communication link 99 exhibiting channel congestion, according to some embodiments of the invention.

The data processing system comprises a transmitter 200 connected via at least one communication link 99 to a receiver 250. Transmitter 200 may comprise at least one encoder 210 arranged to encode the multimedia content the above-noted two encoding schemes simultaneously, comprising a first encoding scheme characterized by a predefined high bit rate and a second encoding scheme characterized by a predefined low bit rate. Transmitter 200 optionally is configured to transmit the multimedia content using the first encoding scheme. Receiver 250 optionally comprises a dynamic switch lag buffer 270 and a control unit 260. Dynamic switch lag buffer 270 includes a predefined buffer size and is configured to receive the transmitted multimedia content. Control unit 260 is optionally configured to measure, record and analyze an incoming packet delay, predict a packet delay, and predict an increase in channel congestion by detecting an increase in the predicted packet delay. Receiver 250 is configured to notify transmitter 200 of the detected channel congestion, and transmitter 200 is configured to switch to transmitting the multimedia content using the second encoding scheme upon receiving the notification of the detected channel congestion from receiver 250. Predicting the packet delay is carried out in a fast and non-obtrusive manner, and continuous live interactive streaming of the multimedia content is sustained despite the increase in channel congestion by a fast and visually seamless switching between the encoding schemes.

In embodiments, the first encoding scheme is characterized by a first predefined GOP and the second encoding scheme is characterized by a second predefined GOP, as noted above. In such embodiments, switch lag buffer 270 is optionally configured to maintain continuous streaming during the switching of the transmitter between the first and the second encoding schemes, in respect to the first predefined GOP and to the second predefined GOP.

According to some embodiments of the invention, control unit 260 may be arranged to check at predefined periods for a relief of the network congestion and report to transmitter 200 of detected relief. Checking for a relief may be carried out by testing refill of switch lag buffer 270. According to some embodiments of the invention, managing module 220 may be configured to switch back to the first encoding scheme upon receiving report of the detection relief. The predefined periods may be determined in relation to at least one of: RTT, switch time at transmitter 200, parameters of the encoding schemes.

According to some embodiments of the invention, receiver 250 and transmitter 200 may be arranged to maintain dynamic switch lag buffer 270, forward the video to de-multiplexing and re-encoding/display or to another communication link, and examine the switch lag buffer refill thereby predicting a decrease in channel congestion, and to notify of relief in congestion based on switch lag buffer refill (stage 155). This may be carried out in parallel to other prediction means. The switch lag buffer refill may be used to indicate relief of channel congestion.

According to some embodiments of the invention, the switch lag buffer size is predefined in relation to at least one of: encoding parameters; first and second predefined bitrates; GOP size; transmission characteristics; RTT; and maximal RTT.

According to some embodiments of the invention, managing module 220 may be arranged to check at predefined periods for a relief of the network congestion and to switch back to the first encoding scheme upon receiving report of the detection relief. The predefined periods may be determined in relation to at least one of: RTT, switch time at the transmitter, parameters of the encoding schemes.

According to some embodiments of the invention, the data processing systems and computer implemented methods manage switching between versions of the multimedia content from various encoders 210 to match the available network bandwidth accurately, and meet delay and continuity constraints. This is carried out in a dynamic and adaptive manner, throughout the transmission.

The data processing systems and computer implemented methods utilize various resources and pre-existing data across the communication path, network channel data, transport channel data and compressed video data that is already mined for loss resiliency and packetized stream reconstruction in prior art receiving modules, for switch lag buffer management. Information about at least one communication link 99 is estimated by receiver 250, by reusing elements and information in the transport stream rebuild phase for packet delay prediction. In this context, a transport stream (e.g. MPEG-2 Transport) is a multiplexed stream of multimedia content prepared for transport, to be further packetized according to communication link type and transmission method, or to be de-multiplexed to several synchronized programs, e.g., video/audio, as part of the stream sequence comprising: communication channel protocol stream; transport stream; primary elementary stream (encoded video/audio); and elementary stream (raw video/audio). The algorithm adaptively switches up or switch down the transmitted bit-rate (i.e., switch between output of different encoders 210 operating simultaneously) and uses knowledge of stream contents for continuous video despite switching of streams. Switch lag buffer 270 at receiver 250 allow gapless, seamless switch down of the transmitted bit-rate and efficient, non-congesting safe switch-ups with constant low delay. Algorithms may be compared in terms of their effects on the decoded multimedia quality by measuring the average streaming bandwidth achieved by each algorithm, maximum delay, the number of stream switches and the data loss (caused due to buffer starvation at receiver 250).

A live video stream using a certain bit-rate will have visual gaps if at any point in time the connection was congested and the bandwidth was down below the threshold needed to transmit that bit-rate. According to some embodiments, the disclosed data processing systems and computer implemented methods solve this problem by using minimally obtrusive packet loss prediction algorithms in at least one communication link 99 and receiver 250 to predict congestion in a manner that dictates down-switching of video bit-rate. When switching down, a period of congestion still exists, part of it accounting for the RTT until the switched down requested video arrives to receiver 250. Dynamic switch lag buffer 270 solves that problem, enabling the system to be predefined to add switch down steps at the cost of delay and if necessary limit delay at the cost of switch down steps.

Switches may be made at certain points in the transmission that allow switching without a loss of fidelity. An algorithm resolves the point to switch at and the implications thereof to the streaming content. In the case of up and down switching the algorithm involves steps to stabilize the video path such that loss resiliency and congestion-readiness demands are maintained.

According to some embodiments of the invention, the size of switch lag buffer 270 is adjusted such as to buffer the streaming while the switch request goes to transmitter 200 and until the congestion is cleared by lowering the bit-rate. RTT may be defined as the “base” time between transmitter 200 sending a particular packet and receiving a corresponding feedback from receiver 250. Switch lag buffer 270 may be regarded as a extension of a client buffer used for dealing with regular oscillations in packet delay (periodic delay variation, or “delay jitter”).

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A computer implemented method of sustaining live interactive streaming of content from a transmitter to a receiver through a communication network exhibiting channel congestion, the computer implemented method comprising:
encoding the multimedia content with at least two encoding schemes simultaneously, a first encoding scheme characterized by a predefined high bit rate and a second encoding scheme characterized by a predefined low bit rate;
transmitting the multimedia content using the first encoding scheme;
receiving and reconstructing the transmitted multimedia content through a dynamic switch lag buffer characterized by a predefined buffer size;
measuring, recording and analyzing an incoming packet delay at the receiver;
predicting a packet delay based on the analyzed incoming packet delay;
predicting an increase in channel congestion by detecting an increase in the predicted packet delay;
notifying the transmitter of the detected channel congestion; and
transmitting the multimedia content using the second encoding scheme upon receiving the notification of the detected channel congestion from the receiver,
wherein the predicting the packet delay is carried out in a fast and non-obtrusive manner, and
wherein continuous live interactive streaming of the multimedia content is sustained despite the increase in channel congestion by a fast and visually seamless switching between the encoding schemes.

2. The computer implemented method of claim 1, further comprising switching the encoding scheme so as to sustain a continuous live interactive streaming of the multimedia content despite the channel congestion.

3. The computer implemented method of claim 2, wherein the multimedia content is Group of Pictures (GOP) based, wherein the first encoding scheme is further characterized by a first predefined GOP and the second encoding scheme is further characterized by a second predefined GOP, and wherein the switching is carried out with respect to the first predefined GOP and to the second predefined GOP such as to maintain continuous streaming.

4. The computer implemented method of claim 1, further comprising checking at predefined periods for a relief of the network congestion.

5. The computer implemented method of claim 4, further comprising switching back to the first encoding scheme upon detection of the relief of the network congestion.

6. The computer implemented method of claim 4, wherein the predefined periods are determined in relation to at least one of: a Round Trip Time (RTT), a switch time at the transmitter, and parameters of the encoding schemes.

7. The computer implemented method of claim 1, further comprising
maintaining the dynamic switch lag buffer having a switch lag buffer refill pattern;
examining the switch lag buffer refill pattern, thereby predicting a decrease in channel congestion; and
notifying the receiver of relief in congestion based on switch lag buffer refill.

8. A data processing system for sustaining live interactive streaming of multimedia content through a communication network comprising at least one communication link and exhibiting channel congestion, the data processing system comprising a transmitter connected, via the communication network, to a receiver,
wherein the transmitter comprises at least one encoder arranged to encode the multimedia content with at least two encoding schemes simultaneously, a first encoding scheme characterized by a predefined high bit rate and a second encoding scheme characterized by a predefined low bit rate, and wherein the transmitter is arranged to transmit the multimedia content using the first encoding scheme,
wherein the receiver comprises:
a dynamic switch lag buffer characterized by a predefined buffer size and switch lag buffer refill state, the dynamic switch lag buffer arranged to receive the transmitted multimedia content; and
a control unit arranged to measure, record and analyze an incoming packet delay, predict a packet delay, and predict an increase in channel congestion by detecting an increase in the predicted packet delay,
wherein the receiver is further arranged to notify the transmitter of the detected channel congestion,
wherein the transmitter is further arranged to switch to transmitting the multimedia content using the second encoding scheme upon receiving the notification of the detected channel congestion from the receiver,
wherein the predicting the packet delay is carried out in a fast and non-obtrusive manner, and
wherein continuous live interactive streaming of the multimedia content is sustained despite the increase in channel congestion by a fast and visually seamless switching between the encoding schemes.

9. The data processing system of claim 8, wherein the multimedia content is Group of Pictures (GOP) based, wherein the first encoding scheme is further characterized by a first predefined GOP and the second encoding scheme is further characterized by a second predefined GOP, and wherein the switch lag buffer is arranged to maintain continuous streaming during the switching of the transmitter between the first and the second encoding schemes, with respect to the first predefined GOP and to the second predefined GOP.

10. The data processing system of claim 8, wherein the control unit is arranged to check at predefined periods for a relief of the network congestion and report the transmitter of detected relief.

11. The data processing system of claim 10, wherein the managing module is arranged to switch back to the first encoding scheme upon receiving report of the detection relief.

12. The data processing system of claim 10, wherein the predefined periods are determined in relation to at least one of: a Round Trip Time (RTT), a switch time at the transmitter, and parameters of the encoding schemes.

13. The data processing system of claim 8, wherein the managing module is arranged to check at predefined periods for a relief of the network congestion and to switch back to the first encoding scheme upon receiving report of the detection relief.

14. The data processing system of claim 13, wherein the predefined periods are determined in relation to at least one of: a Round Trip Time (RTT), a switch time at the transmitter, and parameters of the encoding schemes.

15. The data processing system of claim 13, wherein the switch lag buffer size is predefined in relation to at least one of: encoding parameters; first and second predefined bitrates; GOP size; transmission characteristics; RTT; and maximal RTT.
